(19) United States
(12) Patent Application Publication
(10) Pub. No.: US 2003/0192650 A1
(43) Pub. Date: Oct. 16, 2003

(54) Venetian blind with curtain fabric

(75) Inventor: Ming Nien, Chang Hua Hsien (TW)

Correspondence Address: BACON & THOMAS, PLLC, 625 SLATERS LANE, FOURTH FLOOR, ALEXANDRIA, VA, 22314

(73) Assignee: Nien Made Enterprise Co, Ltd, Chang Hua Hsien (TW)

(21) Appl. No.: 10/162,921

(22) Filed: Jun. 6, 2002

(30) Foreign Application Priority Data
Apr. 11, 2002 (TW) 91204734

(51) Int. Cl. E06B 9/26

(52) U.S. Cl. 160/89

(57) ABSTRACT

A Venetian blind comprises a blind assembly having a head rail, a bottom rail, a plurality of slats and a lift cord assembly for holding the slats in between the head rail and the bottom rail and driving the slats to move between a extended position and a collapsed position, and a plurality of shade fabrics. Each of the shade fabrics has a coupling portion and a shading portion having an end thereof coupled to the coupling portion. Wherein the coupling portions of the shade fabrics are coupled to the slats of the blind assembly respective and the shading portions of the shade fabrics are left at a side of the slats.

### FIELD OF THE INVENTION

The present invention relates generally to a Venetian blind, and more particularly to a Venetian blind with shade fabric.

### BACKGROUND OF THE INVENTION

The Venetian blind is to shade sunshine from illuminating directly via window and to decorate the window. Recently, there is a Venetian blind with a shade fabric installed thereon in the market. The shade fabric is installed on the slats of the Venetian blind and the area thereof is approximately equal to the extended area of the Venetian blind. Therefore, the Venetian blind has a superior performance to shade sunshine.

However, the above-described Venetian blind still has some unsolved problems, such as the shade fabric will be folded irregularly when the Venetian blind had collapsed. Therefore the Venetian blind has a bad look in the collapsed condition. Furthermore, the shade fabric will be stuck in between the slats, so the Venetian blind has a larger size in the collapsed condition. If the shade fabric had been stuck in between the slats, there will be folded traces left on the shade fabric. So, the shade fabric has a bad look in the extended condition.

### SUMMARY OF THE INVENTION

The primary objective of the invention is to provide a Venetian blind, which can prevent the shade fabric being folded.

The second objective of the present invention is to provide a Venetian blind, which installs the shade fabric thereon to provide a fancy look.

According to the objectives of the invention, a Venetian blind comprises a blind assembly having a head rail, a bottom rail, a plurality of slats and a lift cord assembly for holding the slats in between the head rail and the bottom rail and driving the slats to move between a extended position and a collapsed, and a plurality of shade fabrics, each of which has a coupling portion and a shading portion having an end thereof coupled to the coupling portion. Wherein the coupling portions of the shade fabrics are coupled to the slats of the blind assembly respectively and the shading portions of the shade fabrics are left at a side of the slats.

### BRIEF DESCRIPTION OF THE DRAWINGS

FIG. 1 is an exploded view of a first prefer embodiment of the present invention;

FIG. 2 is a perspective view of the first prefer embodiment of the present invention;

FIG. 3 is a lateral view of the first prefer embodiment of the present invention, showing the Venetian blind collapsed;

FIG. 4 is an exploded view of a second prefer embodiment of the present invention;

FIG. 5A is an exploded view of a third prefer embodiment of the present invention;

FIG. 5B is an exploded view of the third prefer embodiment of the present invention, showing the alternate type;

FIG. 6 is an exploded view of a fourth prefer embodiment of the present invention;

FIG. 7 is an exploded view of a fifth prefer embodiment of the present invention, and

FIG. 8 is an exploded view of a sixth prefer embodiment of the present invention.

### DETAIL DESCRIPTION OF THE INVENTION

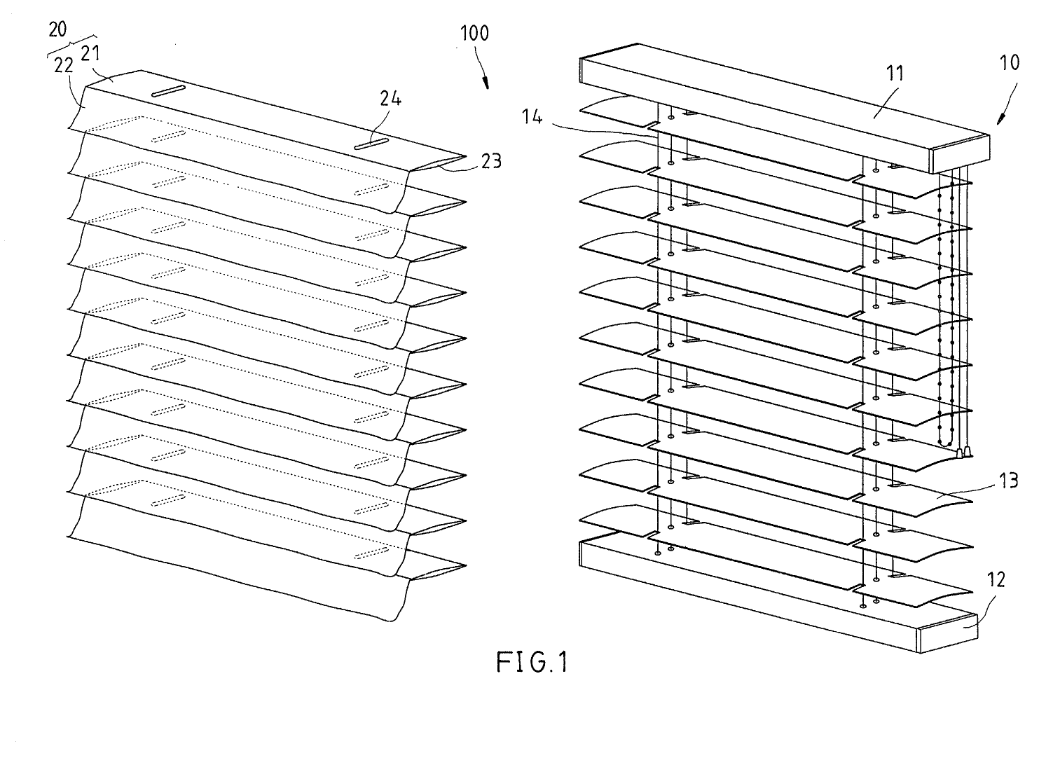

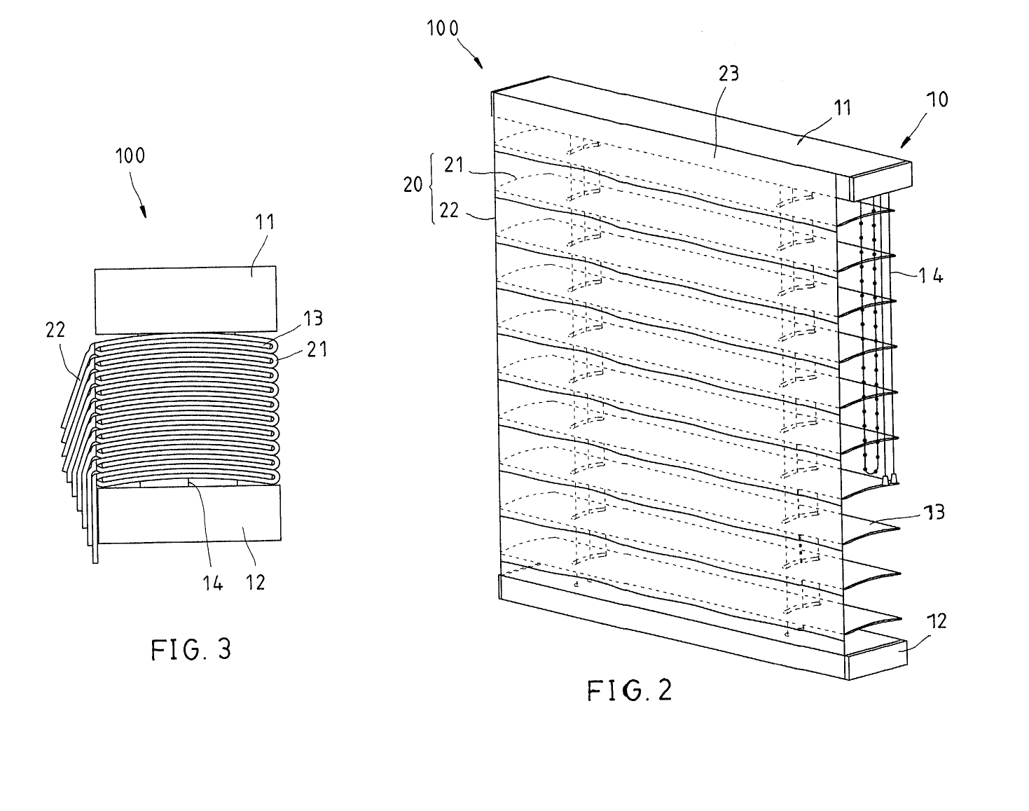

Please refer to FIG. 1 to FIG. 2, the first prefer embodiment of the present invention provides a Venetian blind 100, which comprises a bind assembly 10 and a plurality of shade fabrics 20.

The blind assembly 10 has a head rail 11, a bottom rail 12, a plurality of slats 13 and a lift cord assembly 14.

The head rail 11 is to be secured on the wall above a window. Each slat 13 is installed in between the head rail 11 and the bottom rail 12. The lift cord assembly 14 couples the head rail 11, the bottom rail 12 and the slats 13 together and drives the bottom rail 12 and the slats 13 to lower (extend) and to lift (collapse).

The amount of the shade fabrics 20 is equal to the slats 13 of the blind assembly 10. Each shade fabric 20 has a coupling portion 21 and a shading portion 22 at a side of the coupling portion 21. The coupling portions 21 of the shade fabrics 20 are coupled to the slats 13 respectively for the shading portion 22 being left at a side of the slats 13. In the first prefer embodiment, the coupling portion 21 is an elongated sleeve-like annular fabric, which has a length approximately equal to the length of the slat 13 and has a tunnel 23 therein. The slat 13 is inserted into the tunnel 23 of the coupling portion 21 of the shade fabric 20. The coupling portion 21 further has two openings 24 thereon for the lift cord assembly 14 passing through. The shading portion 22 is a fabric having an end thereof coupling the coupling portion 21 at a side thereof. The shading portion 22 is as long as the slat 13. The shading portion 22 has a width equal to or slightly larger than the distance between two slats 13 in extended condition. So, the shading portions 22 of the shade fabric 20 can shade sunshine.

If the slats 13 are collapsed, the shading portions 22 will overlap at a side of the Venetian blind 100, as shown in FIG. 3, rather than fold. So, the present invention can fix the problem of the conventional Venetian blind, which will folds the shade fabric in collapsed condition.

In addition, the head rail 11 is disposed a fabric piece 25 thereon, please refer to FIG. 2, for masking the gap between the head rail 11 and the top slat 13.

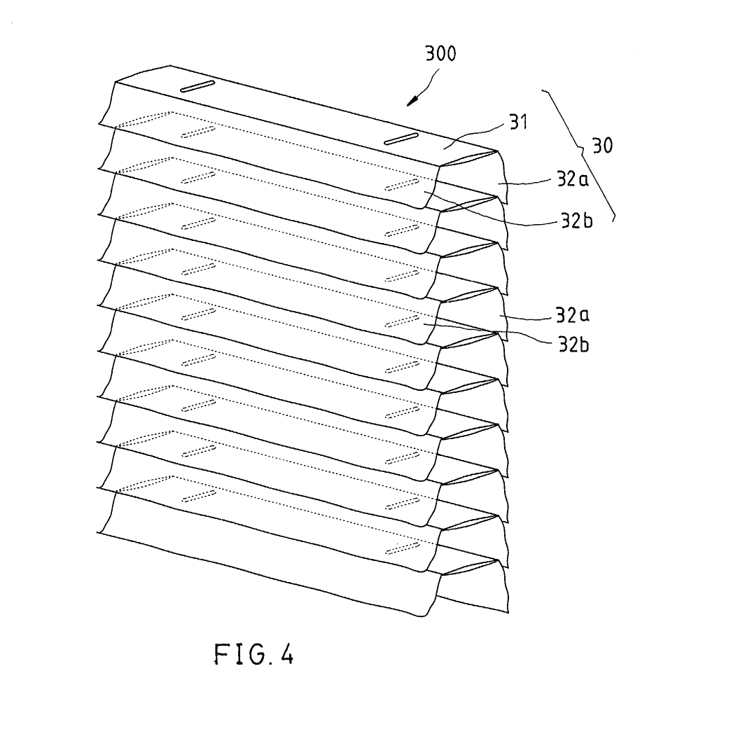

Please refer to FIG. 4, a Venetian blind 300 of the second prefer embodiment of the present invention, which is similar to the Venetian blind 100 of the first prefer embodiment, has a blind assembly (not shown) and a plurality of shade fabrics 30.

Each shade fabric 30 of the second prefer embodiment has a coupling portion 31 and two shading portions 32 disposed at opposite sides of the coupling portion 31 respectively.

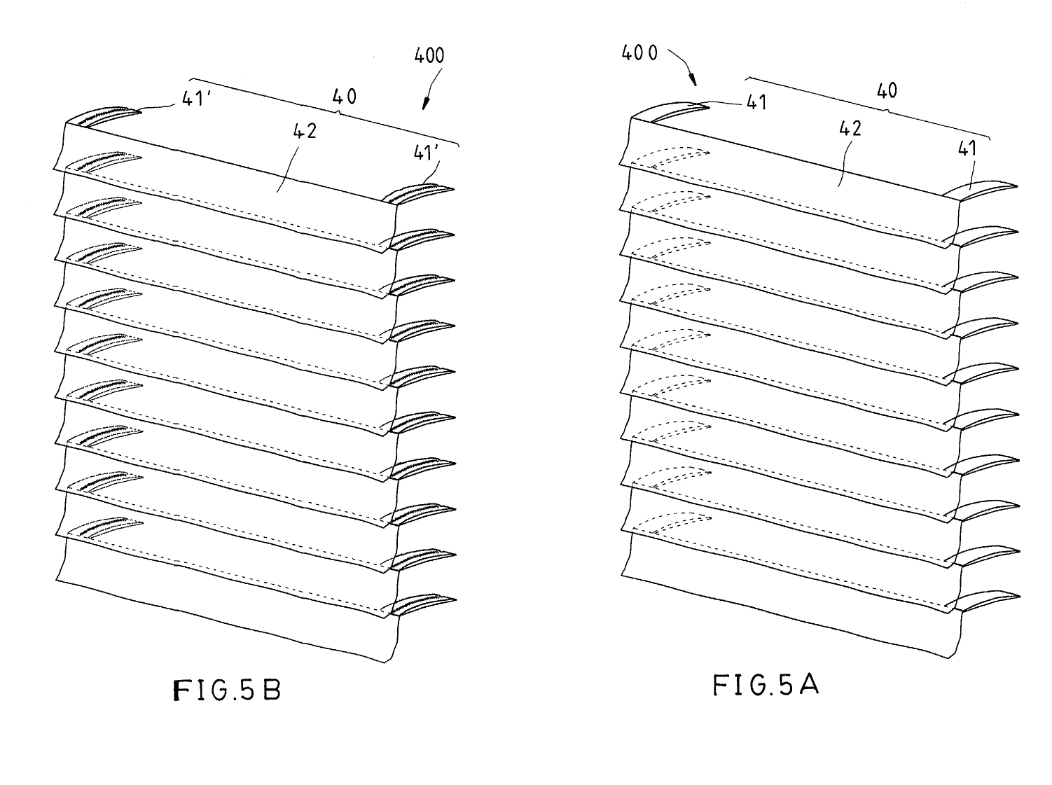

FIG. 5A shows shade fabrics 40 of a Venetian blind 400 of the third prefer embodiment of the present invention, each of which has a coupling portion 41 and a shading portion 42. The coupling portion 41 is two annular fabrics coupled to the shading portion 42 at a side thereof for the slat (not shown) can be inserted into the two annular fabrics 41.

FIG. 5B shows the alternate type of the shade fabrics 40 of the third prefer embodiment of the present invention, each of which has a coupling portion 41′ of two elastic annular fabrics to make the coupling portion 41′ constricted on the slat (not shown).

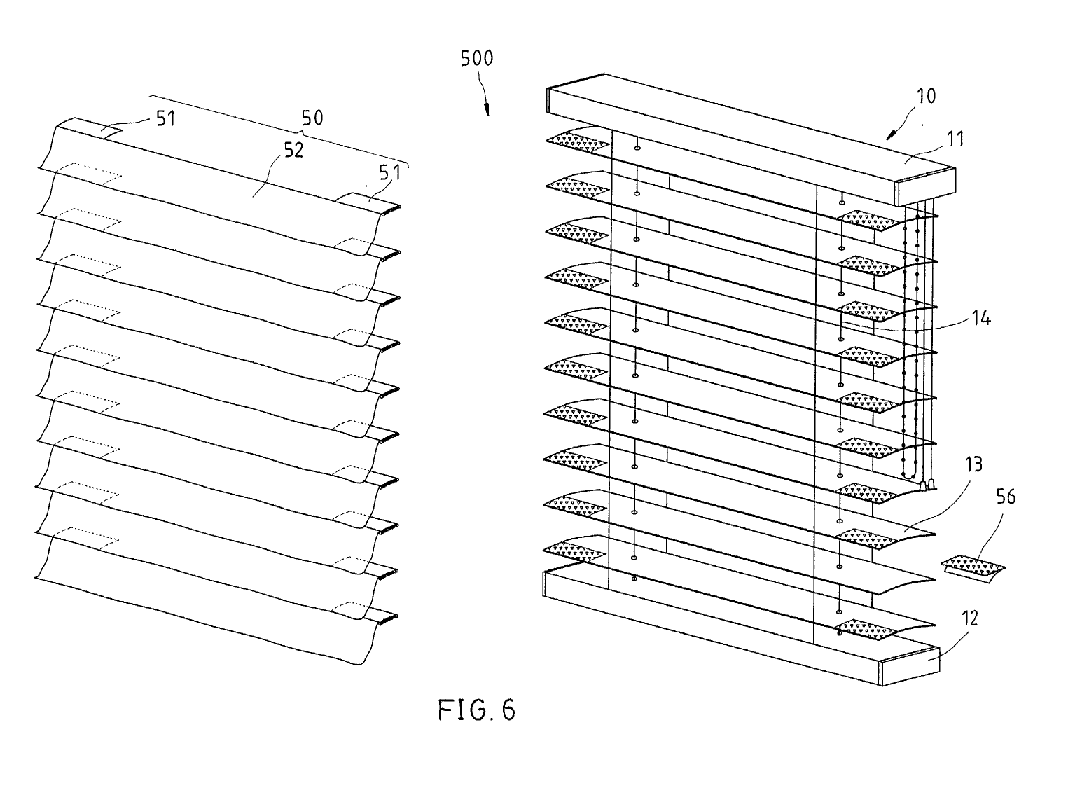

Please refer to FIG. 6, a Venetian blind 500 of the fourth prefer embodiment of the present invention has a blind assembly 10 and a plurality of shade fabrics 50, wherein each shade fabric 50 has a coupling portion 51 and a shading portion 52.

The coupling portion 51 of the shade fabric 50 is two annular fabrics to be installed on the slat 13 of the blind assembly 10. Coupling members 56 are provided between coupling portions 51 and the slats 13 respectively for fix the shade fabrics 50 on the slats 13. Furthermore, the lift cord assembly 14 of the blind assembly 10 does not pass through the coupling portions 51 of the shade fabrics 50, so the shade fabrics 50 are easy to be installed on the slats 13.

The coupling members 56 can be Velcros with the hook pieces stacked on the slats 13 and the loop pieces stacked on the interior sides of the coupling portions 52 respectively. Therefore, the shade fabrics 50 are easy to be coupled to and detached from the slats 13. The coupling members 56 can simply be twin adhesives and the like.

In addition, the coupling portion of the shading portion can be three or more annular fabrics.

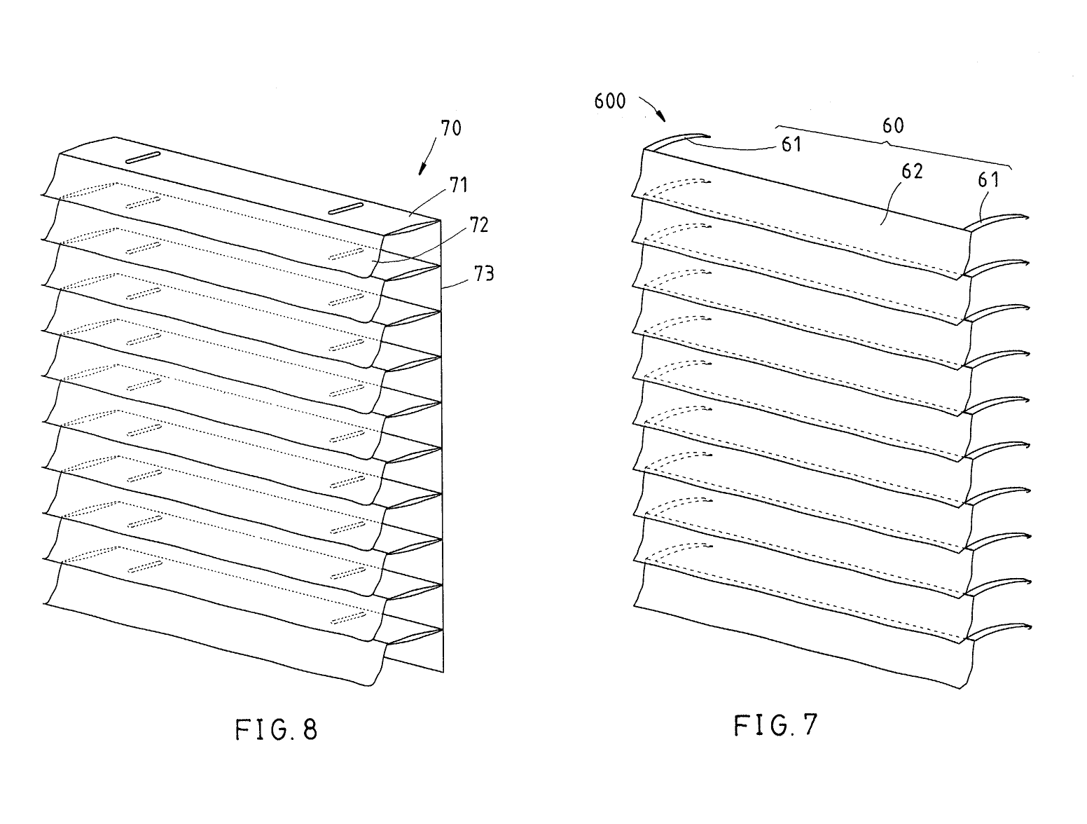

FIG. 7 shows shade fabrics 60 of a Venetian blind 600 of the fifth prefer embodiment of the present invention, each of which has a coupling portion 61 and a plurality of shading portion 62.

The coupling portion 61 of the shade fabric 60 is two flexible members, which can be made from metal or plastics as belts or wires etc. Thus, the flexible members can be deformed, such as bending the flexible members to be a hook-like element as shown in FIG. 7, to be secured on a slat. The flexible members 61 have ends thereof respectively coupled to the shading portion 62 at a side thereof.

FIG. 8 shows shade fabrics 70 of a Venetian blind 700 of the sixth prefer embodiment of the present invention, each of which has a coupling portion 71 and a shading portion 72 coupled at a side of the coupling portion 71. A fabric piece 73 having an area substantially equal to the area of the slats (not shown) in extended condition is coupled to the shade fabrics 70 at the sides of the coupling portions 71 opposite from the shading portions 72.

The advantages of the present invention are:

1. The slats of the Venetian blind has a small size in collapsed condition, where the shade fabrics will be left at a side of the slats rather than struck in between the slats. The shade fabrics also will not be folded to make folded traces thereon.

2. The shade portions of the shade fabrics have free ends that will allow wind passing through, and the shade portions will swing freely while wind blowing. That will make the Venetian blind of the present invention having a fancy look.

What is claimed is:

1. A Venetian blind, comprising:
a blind assembly having a head rail, a bottom rail, a plurality of slats and a lift cord assembly for holding said slats in between said head rail and said bottom rail, and
a plurality of shade fabrics, each of which has a coupling portion and a shading portion having an end thereof coupled to said coupling portion;
wherein said coupling portions of said shade fabrics are coupled to said slats of said blind assembly respectively and said shading portions of said shade fabrics are left at a side of said slats.

2. The Venetian blind as defined in claim 1, wherein the width of said shading portion of said shade fabric is substantially equal to the distance between two of said slats in an extended condition.

3. The Venetian blind as defined in claim 1, wherein the width of said shading portion of said shade fabric is large than the distance between two of said slats in an extended condition.

4. The Venetian blind as defined in claim 1, wherein the amounts of said slats are equal to the amounts of said shade fabrics.

5. The Venetian blind as defined in claim 1, wherein said coupling portion of said shade fabric is an elongated sleeve-like fabric having a length substantially equal to the length of said slat and having a tunnel therein for said slat being inserted into said tunnel of said shade fabric.

6. The Venetian blind as defined in claim 1, wherein said coupling portion of said shade fabric is two annular fabrics having ends coupled to said coupling portion at a side thereof.

7. The Venetian blind as defined in claim 1, wherein said shade fabric has two shading portions respectively coupled to said coupling portion at the opposite sides thereof.

8. The Venetian blind as defined in claim 1 further comprising a fabric piece, which has an area substantially equal to the area of said slats being extended, coupled to said coupling portions of said shade fabrics at the sides opposite from said shading portions.

9. The Venetian blind as defined in claim 1, wherein said coupling portion of said shade fabric is at least two annular fabrics and provides coupling members between said coupling portions of said shade fabrics and said slats.

10. The Venetian blind as defined in claim 1, wherein said coupling portion of said shade fabric is at least one flexible member.

11. The Venetian blind as defined in claim 1, wherein said coupling portion of said shade fabric is at least one elastic annular fabric.
